(19) United States
(12) Patent Application Publication
(10) Pub. No.: US 2006/0190683 A1
(43) Pub. Date: Aug. 24, 2006

(54) Disk array apparatus and backup method of data

(75) Inventor: Syunichi Takase, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/359,387

(22) Filed: Feb. 23, 2006

(30) Foreign Application Priority Data
Feb. 24, 2005 (JP) 2005-049651

(51) Int. Cl. G06F 12/16

(52) U.S. Cl. 711/114

(57) ABSTRACT

A disk array apparatus includes first and second RAID (Redundant Arrays of Inexpensive Disks) groups; and a disk array controller. The first RAID groups includes a first data disk group of a first disk group and a second disk group which store first and second data, respectively; and a first redundant disk configured to store a first redundant data for the first and second data. The second RAID groups includes a second data disk group of a third disk group and a fourth disk group which store second data, respectively; and a second redundant disk configured to store second redundant data for the third and fourth data. Each of the first to fourth disk group includes at least one disk. The disk array controller includes a RAID configuration managing section configured to reconfigure the first to fourth disk groups other than a first specific disk and the first and second redundant disks into a third RAID group when the first specific disk which stores a first specific data is failed in the fourth disk group.

### BACKGROUND OF THE INVENTION

1. Field of the Invention

The present invention relates to a disk array apparatus using a RAID (Redundant Arrays of Inexpensive Disks) system, and a backup method for the same.

2. Description of the Related Art

In a conventional disk array apparatus, when a disk in a RAID group is failed, redundancy is lost. For this reason, in the conventional disk array apparatus, when the disk is failed, a lamp is turned on to indicate the failed disk, and the occurrence of the failure is notified with an alarm. Thus, a service man finds the failure and manually replaces the failed disk by a new disk. Therefore, in the conventional disk array apparatus, when no service man is present or when the new disk is not prepared, the failed disk cannot be replaced promptly, and the disk array apparatus remains for a long period of time under the condition of the redundancy being lost.

As an apparatus to solve the above problem, a disk array apparatus with a hot swap function is known. The disk array apparatus is provided with a hot spare disk at all times, and a failed disk is automatically swapped for the hot spare disk. However, a dedicated spare disk has to be provided at all times to the disk array apparatus, so that the disk array apparatus becomes expensive as a whole. Also, the redundancy is lost when in a disk array apparatus with a hot swap function, the hot-swap is carried out because of one disk being failed and then another disk is further failed. As a result, reliability of the disk array apparatus is lost.

In conjunction with the above description, a data duplexing storage subsystem is disclosed in Japanese Laid Open Patent Application (JP-A-Heisei 11-85410). In the data duplexing storage subsystem of this conventional example, a storage device has a RAID configuration in which a plurality of physical drives are provided on a main storage subsystem side, and a plurality of physical drives are provided on an auxiliary storage subsystem side. When the redundancy is lost due to a failure in the plurality of physical drives on the main storage subsystem side for a first ECC group, the data duplexing storage subsystem reconfigures the first ECC group into a second ECC group, including a physical drive corresponding to the failed physical drive, in order to maintain the redundancy. At the same time, the data duplexing storage subsystem copies the data corresponding to the failed physical drive into one physical drive on a main spare side. After the copy is completed, data redundancy and duplexing are restored and maintained in a third ECC group that includes the main spare drive. Consequently, the redundancy of data lost due to the occurrence of the failure is promptly restored without stopping the system.

Japanese Laid Open Patent Application (JP-P2000-39970A) discloses a double failure preventing control method of a disk array system. The double failure preventing control system of this conventional example is provided with array disks, a first parity generation section, a second parity generation section, a first correction section, and a second correction section. In the array disks, a first parity is generated based on data stored in other disks and is stored in some disks, and a second parity is generated based on data stored in one disk and is stored in the same disk. The first parity generation section generates the above first parity. The second parity generation section generates the above second parity. When a failure occurs in some disks in the array disks, the first correction section corrects data of the failed disk by using data of other disks and the first parity. The second correction section corrects an error from portions other than the error portion, when the error occurs in data stored in a disk in the array disks and the second parity. As a result, even when the failure occurs in the disk and the data is reconfigured to a replacement disk, it is possible to correct data.

Japanese Laid Open Patent Application (JP-P2000-207136A) discloses a multiple drive failure tolerant RAID algorithm. This conventional example provides data backup in a computer system. In this method, N data drives are provided. A check data is calculated between the adjacent two data drives. The check data for all the data drives are stored in one of the data drives.

Japanese Laid Open Patent Application (JP-A-Heisei 9-269871) discloses a data re-redundancy system in a disk array apparatus. The data re-redundancy system of this conventional example has a disk device that includes a plurality of disks, a disk control section to perform input and output to the disk device, a mirroring control section for performing redundancy management such as a mirroring pair to the disk device through the disk control means, and a redundancy management information storage section to store a priority order set in units of the redundancy management. The mirroring control section attains the redundancy of data stored in a disk to be separated due to a failure, according to the priority order. Consequently, the loss of an important data can be prevented as far as on a disk failure does not occur even if another disk failure occurs.

Japanese Laid Open Patent Application (JP-A-Heisei 10-260790) discloses an information record method in a disk array apparatus. In the information record method of this conventional example, M*N disks are arranged in a matrix. For every column, a parity of information stored in the disks is stored in at least one disk in the column. For every row, a parity of data stored in corresponding sectors of the disks of the same row is stored in at least one disk in the same row.

### SUMMARY OF THE INVENTION

An object of the present invention is to provide a disk array apparatus capable of securing redundancy when a single disk is failed, without a hot spare disk.

Another object of the present invention is to provide a disk array apparatus capable of reproducing data of a failed disk even if two or more disks are failed.

In an aspect of the present invention, a disk array apparatus includes first and second RAID (Redundant Arrays of Inexpensive Disks) groups; and a disk array controller. The first RAID groups includes a first data disk group of a first disk group and a second disk group which store first and second data, respectively; and a first redundant disk configured to store a first redundant data for the first and second data. The second RAID groups includes a second data disk group of a third disk group and a fourth disk group which store second data, respectively; and a second redundant disk configured to store second redundant data for the third and fourth data. Each of the first to fourth disk group includes at least one disk. The disk array controller includes a RAID configuration managing section configured to reconfigure the first to fourth disk groups other than a first specific disk and the first and second redundant disks into a third RAID group when the first specific disk which stores a first specific data is failed in the fourth disk group.

Here, the RAID configuration managing section may issue a first redundant data generation instruction when the first specific disk is failed in the fourth disk group. The disk array controller may further include a redundant data generating section configured to generate a third redundant data based on the first to third data, the fourth data other than a data corresponding to the first specific disk, and the second redundant data, and write the third redundant data into the first redundant disk, in response to the first redundant data generation instruction.

In this case, the redundant data generating section may calculate a first exclusive OR of the first to third data, the fourth data other than a data corresponding to the first specific disk, and the second redundant data in response to the first redundant data generation instruction, generate the third redundant data by inverting a first exclusive OR calculation result, and write the third redundant data into the first redundant disk.

Also, the RAID configuration managing section may issue a first data reproduction instruction to the first specific disk from a read command to the first specific disk. The disk array controller may further include a data reproducing section configured to reproduce the first specific data based on the third data, the fourth data other than a data corresponding to the first specific disk, and the second redundant data in response to the first data reproduction instruction to the first specific disk.

In this case, the data reproducing section may calculate a second exclusive OR of the third data, the fourth data other than the data corresponding to the first specific disk, and the second redundant data in response to the data reproduction instruction to the first specific disk, and reproduce the first specific data by inverting the second exclusive OR calculation result.

Also, the RAID configuration managing section may reconfigure the first and second RAID groups from the third RAID group when the first specific disk is replaced by a new normal disk, and issue a second data reproduction instruction and a second redundant data generation instruction. The disk array controller may further include a data reproducing section configured to reproduce the first specific data based on the third data, the fourth data other than a data corresponding to the first specific disk, and the second redundant data in response to the second data reproduction instruction, and write the first specific data in the new normal disk. The redundant data generating section may generate the first redundant data based on the first and second data in response to the second redundant data generation instruction, and write the first redundant data in the first redundant disk.

In this case, the data reproducing section may calculate a third exclusive OR of the third data, the fourth data other than a data corresponding to the first specific disk, and the second redundant data in response to the second data reproduction instruction, generate the first specific data by inverting the third exclusive OR calculation result and write the first specific data in the new normal disk. The redundant data generating section may calculate a fourth exclusive OR of the first and second data in response to the second redundant data generation instruction, generate the first redundant data by inverting the fourth exclusive OR calculation result and write the first redundant data in the first redundant disk.

Also, when a second specific disk which stores a second specific data is failed in the first to fourth disk groups in a state that the first specific disk is failed, the RAID configuration managing section may issue a third data reproduction instruction in response to a read command to the second specific disk. The disk array controller may further include a data reproducing section configured to reproduce the second specific data based on the first to third data other than a data corresponding to the second specific disk, the fourth data other than a data corresponding to the first specific disk, and the first and second redundant data in response to the third data reproduction instruction.

In this case, the data reproducing section may calculate a fifth exclusive OR of the first to third data other than a data corresponding to the second specific disk, the fourth data other than a data corresponding to the first specific disk, and the first and second redundant data in response to the third data reproduction instruction and generate the first specific data by inverting the fifth exclusive OR calculation result.

Also, when a second specific disk which stores a second specific data is failed in the first to fourth disk groups in a state that the first specific disk is failed, the RAID configuration managing section may issue fourth and fifth data reproduction instructions in response to a read command to the first specific disk. The disk array controller may further include a data reproducing section configured to reproduce the second specific data based on the first to third data other than a data corresponding to the second specific disk, the fourth data other than a data corresponding to the first specific disk, and the first and second redundant data in response to the fourth data reproduction instruction, and to reproduce the first specific data based on the second redundant data, and the second specific data, in addition to the third and fourth data other than the data corresponding to the first and second specific disks in case of the second specific disk contained in the third or fourth disk group and the third data and the fourth data other than the data corresponding to the first specific disk in case of the second specific disk not contained in the third or fourth disk group, in response to the fifth data reproduction instruction.

In this case, the data reproducing section may calculate a sixth exclusive OR of the first to third data other than a data corresponding to the second specific disk, the fourth data other than a data corresponding to the first specific disk, and the first and second redundant data in response to the fourth data reproduction instruction, generate the second specific data by inverting the sixth exclusive OR calculation result, and calculate a seventh exclusive OR of the second redundant data, and the second specific data, in addition to the third and fourth data other than the data corresponding to the first and second specific disks in case of the second specific disk contained in the third or fourth disk group and the third data and the fourth data other than the data corresponding to the first specific disk in case of the second specific disk not contained in the third or fourth disk group, in response to the fifth data reproduction instruction, and generate the first specific data by inverting the seventh exclusive OR calculation result.

Also, in another aspect of the present invention, a backup method in a disk array apparatus, is achieved by providing a disk array apparatus which includes first and second RAID (Redundant Arrays of Inexpensive Disks) groups; and a disk array controller, wherein the first RAID groups comprises a first data disk group of a first disk group and a second disk group which store first and second data, respectively; and a first redundant disk configured to store a first redundant data for the first and second data; wherein the second RAID groups comprises a second data disk group of a third disk group and a fourth disk group which store second data, respectively; and a second redundant disk configured to store second redundant data for the third and fourth data, each of the first to fourth disk group including at least one disk; by reconfiguring the first to fourth disk groups other than a first specific disk and the first and second redundant disks into a third RAID group when the first specific disk which stores a first specific data is failed in the fourth disk group; by issuing a first redundant data generation instruction when the first specific disk is failed in the fourth disk group in response to the first redundant data generation instruction; by generating a third redundant data based on the first to third data, the fourth data other than a data corresponding to the first specific disk, and the second redundant data; and by writing the third redundant data into the first redundant disk.

Here, the generating a third redundant data may be achieved by calculating a first exclusive OR of the first to third data, the fourth data other than a data corresponding to the first specific disk, and the second redundant data in response to the first redundant data generation instruction; and by generating the third redundant data by inverting a first exclusive OR calculation result.

Also, the backup method may be achieved by further issuing a first data reproduction instruction to the first specific disk from a read command to the first specific disk; and reproducing the first specific data based on the third data, the fourth data other than a data corresponding to the first specific disk, and the second redundant data in response to the first data reproduction instruction.

In this case, the reproducing the first specific data may be achieved by calculating a second exclusive OR of the third data, the fourth data other than the data corresponding to the first specific disk, and the second redundant data in response to the data reproduction instruction to the first specific disk; and by generating the first specific data by inverting the second exclusive OR calculation result.

Also, the backup method may be achieved by further reconfiguring the first and second RAID groups from the third RAID group when the first specific disk is replaced by a new normal disk; issuing a second data reproduction instruction and a second redundant data generation instruction; reproducing the first specific data based on the third data, the fourth data other than a data corresponding to the first specific disk, and the second redundant data in response to the second data reproduction instruction; writing the first specific data in the new normal disk; generating the first redundant data based on the first and second data in response to the second redundant data generation instruction; and writing the first redundant data in the first redundant disk.

In this case, the reproducing the first specific data may be achieved by calculating a third exclusive OR of the third data, the fourth data other than a data corresponding to the first specific disk, and the second redundant data in response to the second data reproduction instruction; and by generating the first specific data by inverting the third exclusive OR calculation result. Also, the generating the first redundant data may be achieved by calculating a fourth exclusive OR of the first and second data in response to the second redundant data generation instruction; and by generating the first redundant data by inverting the fourth exclusive OR calculation result.

Also, the backup method may be achieved by further issuing a third data reproduction instruction in response to a read command to a second specific disk when the second specific disk which stores a second specific data is failed in the first to fourth disk groups in a state that the first specific disk is failed; and reproducing the second specific data based on the first to third data other than a data corresponding to the second specific disk, the fourth data other than a data corresponding to the first specific disk, and the first and second redundant data in response to the third data reproduction instruction.

In this case, the reproducing the second specific data may be achieved by calculating a fifth exclusive OR of the first to third data other than a data corresponding to the second specific disk, the fourth data other than a data corresponding to the first specific disk, and the first and second redundant data in response to the third data reproduction instruction; and by generating the first specific data by inverting the fifth exclusive OR calculation result.

Also, the backup method may be achieved by further issuing fourth and fifth data reproduction instructions in response to a read command to the first specific disk, when a second specific disk which stores a second specific data is failed in the first to fourth disk groups in a state that the first specific disk is failed; reproducing the second specific data based on the first to third data other than a data corresponding to the second specific disk, the fourth data other than a data corresponding to the first specific disk, and the first and second redundant data in response to the fourth data reproduction instruction; and reproducing the first specific data based on the second redundant data, and the second specific data, in addition to the third and fourth data other than the data corresponding to the first and second specific disks in case of the second specific disk contained in the third or fourth disk group and the third data and the fourth data other than the data corresponding to the first specific disk in case of the second specific disk not contained in the third or fourth disk group, in response to the fifth data reproduction instruction.

In this case, the reproducing the second specific data may be achieved by calculating a sixth exclusive OR of the first to third data other than a data corresponding to the second specific disk, the fourth data other than a data corresponding to the first specific disk, and the first and second redundant data in response to the fourth data reproduction instruction; and by generating the second specific data by inverting the sixth exclusive OR calculation result. Also, the reproducing the first specific data may be achieved by calculating a seventh exclusive OR of the second redundant data, and the second specific data, in addition to the third and fourth data other than the data corresponding to the first and second specific disks in case of the second specific disk contained in the third or fourth disk group and the third data and the fourth data other than the data corresponding to the first specific disk in case of the second specific disk not contained in the third or fourth disk group, in response to the fifth data reproduction instruction; and by generating the first specific data by inverting the seventh exclusive OR calculation result.

### BRIEF DESCRIPTION OF THE DRAWINGS

FIG. 1 is a block diagram showing a configuration of a disk array apparatus according to an embodiment of the present invention;

FIG. 2 is a flow chart showing an operation of the disk array apparatus of the present invention;

FIG. 3 is a flow chart showing another operation of the disk array apparatus of the present invention;

FIG. 4 is a flow chart showing a still another operation of the disk array apparatus of the present invention;

FIG. 5 is a diagram showing the operation of the disk array apparatus of the present invention; and

FIG. 6 is a diagram showing another operation of the disk array apparatus of the present invention.

### DESCRIPTION OF THE PREFERRED EMBODIMENTS

Hereinafter, a disk array apparatus of the present invention will be described in detail with reference to the attached drawings.

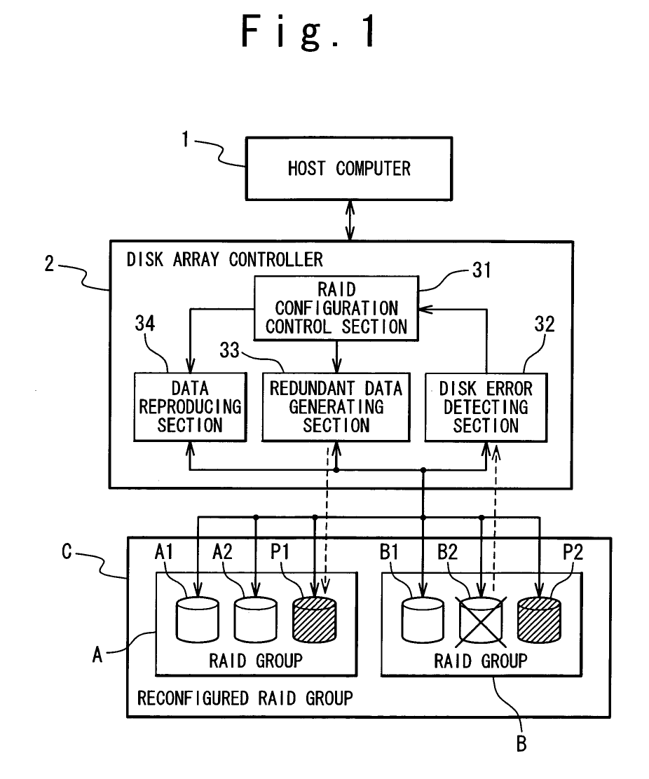

FIG. 1 is a block diagram showing a configuration of the disk array apparatus according to an embodiment of the present invention. The disk array apparatus of the present invention is provided with a host computer 1, a disk array controller 2, a first RAID (Redundant Arrays of Inexpensive Disks) group A, and a second RAID group B. The disk array controller 2 is connected to a host computer 1, the first RAID group A, and the second RAID group B, and carries out the control to the first RAID group A and the second RAID group B.

The first RAID group A has first data disk group including data disk groups A1 and A2, and a first redundant disk P1. Each of the data disk groups A1 and A2 includes at least one data disk. First and second data are written or stored into the data disk groups A1 and A2, respectively. A first redundant data for the first and second data is stored in the first redundant disk P1. The second RAID group B has a second data disk group including data disk groups B1 and B2, and a second redundant disk P2. Each of the data disk groups B1 and B2 includes at least one data disk. Third and fourth data are stored in the data disk groups B1 and B2, respectively. A second redundant data for the third and fourth data is stored in the second redundant disk P2.

The disk array controller 2 has a disk error detecting section 32, a RAID configuration control section 31, a redundant data generating section 33, and a data reproducing section 34. The disk error detecting section 32 detects that a failure has occurred in any data disk of the first RAID group A and the second RAID group B. In this example, it is assumed that a data disk D1 is failed in the data disk group B2. When detecting the failure, the disk error detecting section 32 outputs a disk failure notice to the RAID configuration control section 31 to indicate the occurrence of the failure in the data disk D1. The RAID configuration control section 31 separates the failed data disk D1 from the remaining normal disks in the first RAID group A or the second RAID group B, in response to the disk failure notice from the disk error detecting section 32. At the same time, when the failed data disk D1 is contained in the data disk group B2 of the second RAID group B, the RAID configuration control section 31 reconfigures the first RAID group A and the second RAID group B, that is, generates a new RAID group C by integrating or combining the first RAID group A, the data disk group B1 in the second RAID group B, and remaining data disks of the data disk group B2, and outputs a redundant data generation instruction to the redundant data generating section 33. The redundant data generating section 33 generates a third redundant data for the new RAID group C in response to with the redundant data generation instruction from the RAID configuration control section 31. The data reproducing section 34 reproduces data stored in the failed data disk D1 in response to a reproduction instruction from the raid configuration control section 31.

The operation of the disk array apparatus of the present invention will be described below with reference to FIGS. 1 to 4. In an example shown in FIG. 1, it is assumed that the data disk D1 in the second data disk groups B1 and B2 of the second RAID group B is failed.

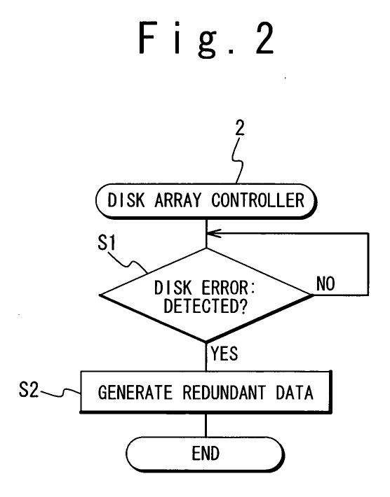

Referring to FIG. 2, the disk error detecting section 32 detects a failure of one data disk D1 of the data disk group B2 in the second RAID group at a step S1. In this case, the disk error detecting section 32 sends the disk failure notice to the RAID configuration control section 31 to indicate that the failure has occurred in the data disk D1 of the group B2. In response to the disk failure notice, the RAID configuration control section 31 separates the failed data disk D1 of the group B2 from remaining disks of the group B2 in the second RAID group B, to constitute a third data disk group B3 of the group B1 and the group B2 other than the failed data disk, in the second RAID group B. At the same time, the RAID configuration control section 31 once separates the first redundant disk P1 from the first RAID group A in a normal operation state, and outputs a redundant data generation instruction to the redundant data generating section 33. The redundant data generating section 33 generates a third redundant data for a third RAID group C based on the first to third data, the fourth data other than data corresponding to the failed data disk D1, and the second redundant data stored in the second redundant disk P2 at a step S2. The redundant data generating section 33 stores the third redundant data into the first redundant disk P1. Thus, the new RAID group C is reconfigured, which includes the first data disk groups A1 and A2, the first redundant disk P1, the third data disk group B3, and the second redundant disk P2.

As described above, it is possible in the disk array apparatus of the present embodiment, to secure the redundancy without a hot spare disk when one data disk D1 of the data disk group B2 is failed.

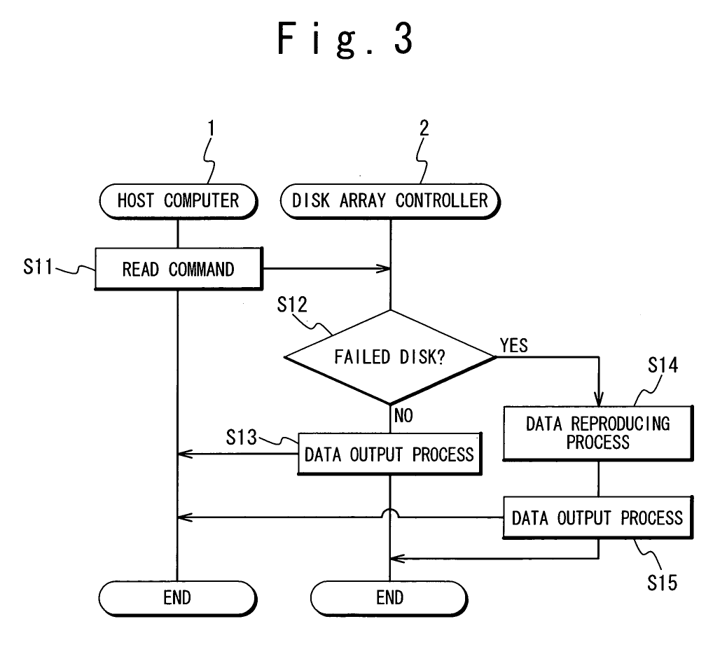

It is assumed that the host computer 1 outputs a read command to the disk array controller 2 to read out the first data from the first data disk A1 (step S11 in FIG. 3). The data reproducing section 34 of the disk array controller 2 receives the read command from the host computer 1 (step S12—NO in FIG. 3). In response to the read command, the data reproducing section 34 reads out the first data from the first data disk group A1, and outputs the first data to the host computer 1 (step S13 in FIG. 3). This is a normal read and write operation.

On the other hand, it is assumed that when only the one D1 of the data disk group B2 is failed, the host computer 1 outputs the read command to the disk array controller 2 to read out the fourth data of the data disk group B2 containing the failed data disk D1, (step S11 in FIG. 3). The data reproducing section 34 of the disk array controller 2 receives the read command from the host computer 1 (step S12—YES in FIG. 3). In response to the read command, the data reproducing section 34 reproduces the fourth data based on the data stored in the third data disk group B3 and the second redundant data of the second redundant disk P2 (step S14 in FIG. 3). Then, the data reproducing section 34 outputs the reproduction data to the host computer 1 (step S15 in FIG. 3).

As described above, it is possible in the disk array apparatus of the present invention, to carry out the read and write operations to the first RAID group A and the second RAID group B, since the redundancy is already secured even when one D1 of the data disk group B2 is failed.

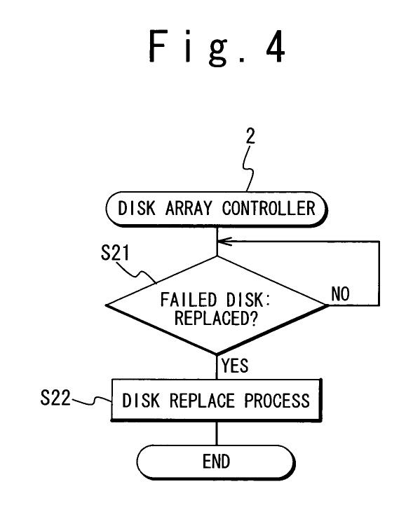

Also, when the data disk D1 in the group B2 is failed, the failed data disk D1 is replaced with a new normal data disk. In this case, the host computer 1 outputs a replace completion notice to the disk array controller 2 to indicate that the failed data disk has been replaced. The data reproducing section 34 of the disk array controller 2 receives the replace completion notice from the host computer 1 (step S21—YES in FIG. 4). In response to the replace completion notice, the data reproducing section 34 reproduces data of the failed data disk D1 based on the data of the third data disk group B3 and the second redundant data of the second redundant disk P2. Then, the data reproducing section 34 writes the reproduced data into the new normal data disk. At the same time, the data reproducing section 34 generates the first redundant data for the first and second data of the data disk groups A1 and A2, and writes the generated first redundant data in the first redundant disk P1 (step S22 in FIG. 4). As described above, it is possible in the disk array apparatus of the present invention, to reproduce the data structure of the original first RAID group A and second RAID group B when the failed data disk D1 is exchanged with the normal data disk, since the redundancy is already secured when the data disk D1 is failed.

Next, a case that when the data disk D1 is under failure, another data disk D2 is failed in the above third data disk group B3 will be described below.

It is assumed that the disk error detecting section 32 detects a failure of the data disk D2 in the third data disk group B3 (step S1—YES in FIG. 2). In this case, the disk error detecting section 32 sends another disk failure notice to the RAID configuration control section 31 to indicate the failure of the data disk D2. Receiving the disk failure notice, the RAID configuration control section 31 separates the failed data disk D2 from the above third data disk group B3 to generate a fourth data disk group B4 of remaining normal data disks. The RAID configuration control section 31 does not issue the redundant data generation instruction to the redundant data generating section 33, when receiving the disk failure notice. That is to say, the redundant data generating section 33 does not perform the step S2.

When the data disks D1 and D2 are under failure, the host computer 1 outputs the read command to the disk array controller 2 to read out the data of the failed data disk D2 (step S11 in FIG. 3). The data reproducing section 34 of the disk array controller 2 receives the read command from the host computer 1 (step S12—YES in FIG. 3). In response to the read command, the data reproducing section 34 reproduces the data of the failed data disk D2 based on the first data and second data of the first and second data disk groups A1 and A2, the third redundant data of the first redundant disk P1, a data of the fourth data disk group, and the second redundant data of the second redundant disk P2 (step S14 in FIG. 3). At this time, if the failed data disk D2 is present in the data disk group A1 or A2, the first data and second data of the first and second data disk groups A1 and A2 other than data corresponding to the failed data disk D2, the third redundant data of the first redundant disk P1, the data of the third data disk group, and the second redundant data of the second redundant disk P2. Then, the data reproducing section 34 outputs the reproduction data to the host computer 1 (step S15 in FIG. 3). As described above, it is possible in the disk array apparatus of the present invention, to reproduce data of the failed data disk D2 even if the data disk D2 is failed after the data disk D1 is failed, since the redundancy is already secured when the data disk D1 is failed.

When the data disks D1 and D2 are under failure, the host computer 1 outputs the read command to the disk array controller 2 to read the data of the failed data disk D1 (step S11 in FIG. 3). The data reproducing section 34 of the disk array controller 2 receives the read command from the host computer 1 (step S12—YES in FIG. 3). In response to the read command, the data reproducing section 34 reproduces the data of the failed data disk D2 as described above. Subsequently, the data reproducing section 34 reproduce a data of the failed data disk D1, based on the reproduction data of the failed data disk D2, and the second redundant data of the second redundant disk P2 (step S14 in FIG. 3), and outputs the reproduction data to the host computer 1 (step S15 in FIG. 3). As described above, it is possible in the disk array apparatus of the present invention, to reproduce data of the failed data disk D1 even if the data disk D2 is failed after the data disk D1 is failed, since the redundancy is already secured when the data disk D1 is failed.

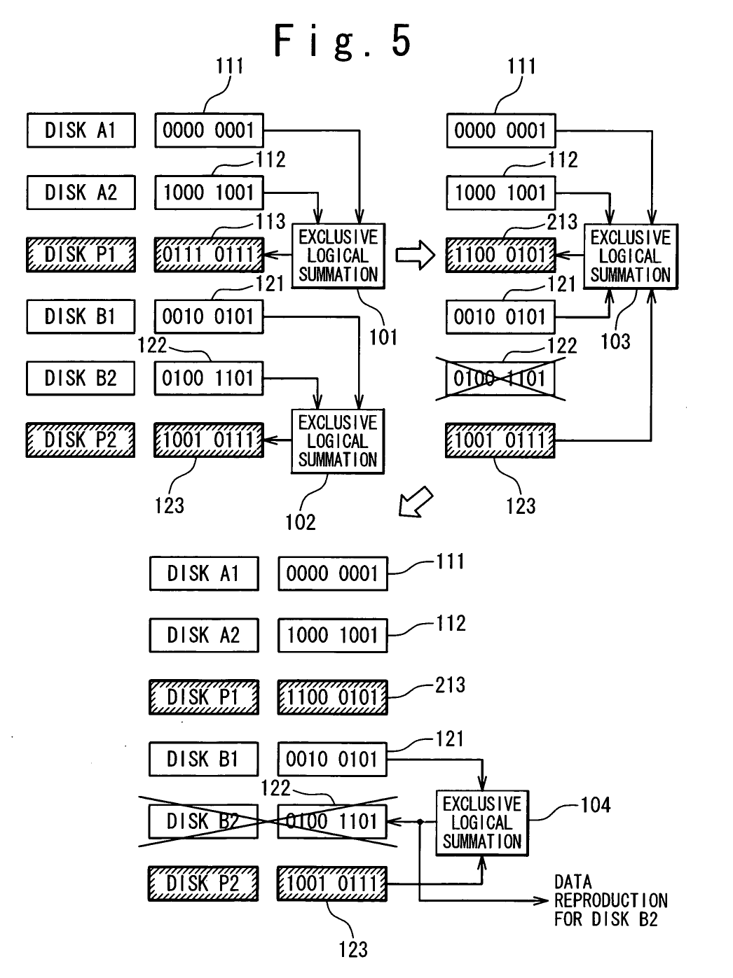

Next, an operation example of the disk array apparatus of the present invention will be described below with reference to FIG. 5. Here, each of the data disk groups A1, A2, B1 and B2 contains a single data disk, and the structure of a redundant disk used in the disk array apparatus of the present invention includes mirroring and parity. In this case, the structure and effect of the present invention do not change, and the structure and effect do not change regardless of whether a failed disk is a data disk or a redundant disk.

In an example shown in FIG. 5, odd parities are allocated to redundant disks in the disk array apparatus having the configuration in FIG. 1, and a numeric value is actually set in the above data. First, the setting of the numeric value will be described.

In the first RAID group A, a data 111 “0000 0001” and a data 112 “1000 1001” are written into the first and second data disks A1 and A2, respectively. The redundant data generating section 33 calculates an exclusive OR 101 of the data 111 “0000 0001” of the data disk A1 and the data 112 “1000 1001” of the data disk A2 in the first disk group, to generate a data “1000 1000”. The redundant data generating section 33 carries out bit inversion, that is, inverts the data “1000 1000” in units of bits. Thus, a data 113 “0111 0111” is obtained as a first redundant data. Then, the redundant data generating section 33 writes the data 113 “0111 0111” to the first parity disk P1. Also, in the second RAID group B, a data 121 “0010 0101” and a data 122 “0100 1101” are written into the data disks B1 and B2 in the second data disk group, respectively. The redundant data generating section 33 calculates an exclusive OR 102 of the data 121 “0010 0101” of the data disk B1 and the data 122 “0100 1101” of the data disk B2, to generate a data “1011 1000”. The redundant data generating section 33 carries out bit inversion of the data “1011 1000”. Thus, a data 123 “1001 0111” is obtained as a second redundant data string. Then, the redundant data generating section 33 writes the data 123 “1001 0111” into the second parity disk P2.

If the disk error detecting section 32 detects the failure of the second data disk B2 as the failed disk D1 (the above step S1—YES), the redundancy of the second RAID group B is lost. For this reason, the RAID configuration control section 31 separates the data disk B2 from the second RAID group B, and once relieves the first parity disk P1 of the first RAID group A. Subsequently, at the above step S2, the redundant data generating section 33 calculates an exclusive OR 103 of the data 111 “0000 0001” of the first data disk A1, the data 112 “1000 1001” of the first data disk A2, the data 121 “0010 0101” of the second data disk B1, and the data 123 “1001 0111” of the second parity disk P2, to generate a parity data 213 “1100 0101” as the above third redundant data. The redundant data generating section 33 then writes the parity data 213 “1100 0101” into the first parity disk P1. As a result, a single parity disk P1 is generated with a combination of the first RAID group A and the second RAID group B, and the redundancy is secured.

When the data of the second data disk B2 are read out from the host computer 1 at the above steps S11 and S12—YES, the second data disk B2 under failure is in the separated state. For this reason, in the above step S14, the data reproducing section 34 calculates an exclusive OR 104 of the data 121 “0010 0101” of the second data disk B1 and the second redundant data 123 “1001 0111” of the second parity disk P2, and reproduces the data 122 “0100 1101” of the second data disk B2 by inverting the exclusive OR result. After that, at the above step S15, the data reproducing section 34 outputs the reproduced data 122 “0100 1101” to the host computer 1.

When the failed data disk B2 is replaced by a new normal data disk at the above step S21—YES, the data reproducing section 34 carries out the above step S22. In this case, the data reproducing section 34 calculates the exclusive OR 104 of the data 121 “0010 0101” of the second data disk B1 and the data 123 “1001 0111” of the second parity disk P2, and reproduces the data 122 “0100 1101” by inverting the exclusive OR calculation result. By writing the reproduced data 122 “0100 1101” into the new normal data disk B2, it is possible to reproduce the configuration of the original second RAID group B.

Also, the data reproducing section 34 calculates the exclusive OR 101 of the data 111 “0000 0001” of the first data disk A1 and the data 112 “1000 1001” of the first data disk A2, and generates the data 113 “0111 0111” by inverting the exclusive OR calculation result. The data reproducing section 34 then writes the data 113 “0111 0111” into the first parity disk P1, making it possible to reproduce the configuration of the original first RAID group A.

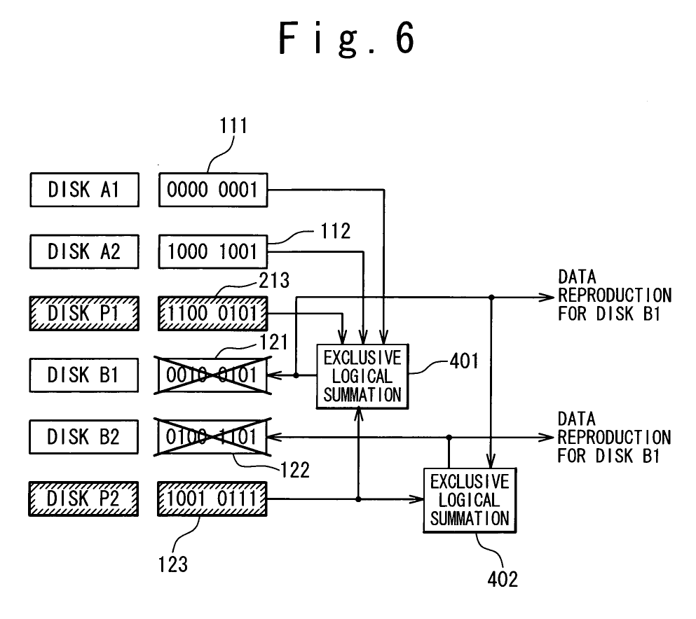

An example shown in FIG. 6 shows an operation when a second data disk B1 is further failed after the second data disk B2 is failed. Here, the operation when the second data disk B2 is failed is as stated above. When the second data disk B1 is failed after reconfiguration of the third RAID group C, reproduction of the data disks B1 and B2 is possible though the redundancy is lost at the time of the failure.

At the above steps S11 and S12—YES, the data of the data disk B1 is read out by the host computer 1. In this case, the data disk B1 under failure has been separated. Therefore, at the above step S14, the data reproducing section 34 calculates an exclusive OR 401 of the data 111 “0000 0001” of the data disk A1, the data 112 “1000 1001” of the data disk A2, the data 213 “1100 0101” of the first parity disk P1, and the data 123 “1001 0111” of the second parity disk P2, and reproduce the data 121 “0010 0101” of the second data disk B1 by inverting the exclusive OR calculation result. The data reproducing section 34 then outputs the reproduced data 121 “0010 0101” to the host computer 1.

Also, at the above steps S11 and S12—YES, the data of the second data disk B1 is read out by the host computer 1. In this case, the second data disks B1 and B2 under failure have been separated. For this reason, at the above step S14, the data reproducing section 34 first calculates the above exclusive OR 401, to reproduce the data 121 “0010 0101” of the second data disk B1. Then, the data reproducing section 34 then calculates an exclusive OR 402 of the data 121 “0010 0101” of the second data disk B1 and the data 123 “1001 0111” of the second parity disk P2, and reproduces the data 122 “0100 1101” of the second data disk B2 by inverting the exclusive OR calculation result. The data reproducing section 34 then outputs the reproduced data 121 “0010 0101” and data 122 “0100 1101” to the host computer 1.

When the failed data disks B1 and B2 are replaced by normal data disks B1 and B2 at the above step S21—YES, the data reproducing section 34 carries out the above step S22. At this time, the data reproducing section 34 calculates the above exclusive OR 401, and reproduces the data 121 “0010 0101” of the second data disk B1 by inverting the exclusive OR calculation result, and writes the reproduced data 121 “0010 0101” into the normal data disk B1. Then, the data reproducing section 34 calculates the above exclusive OR 402, and reproduces the data 122 “0100 1101” of the second data disk B2 by inverting the exclusive OR calculation result, and writes the reproduced data 122 “0100 1101” into the normal data disk B2. Consequently, it is possible to reproduce the configuration of the original second RAID group B. Also, the data reproducing section 34 calculates the above exclusive OR 101 to generate the data 113 “0111 0111” by inverting the exclusive OR calculation result, and writes the generated data 113 “0111 0111” into the first parity disk P1. Consequently, it is possible to reproduce the structure of the original first RAID group A.

As described above, according to the disk array apparatus of the present invention, it is possible to secure the redundancy without a hot spare disk when a single disk is failed. More specifically, according to the disk array apparatus of the present invention, it is possible to realize the redundancy in a short period of time without manpower, since a redundant disk of another RAID group is used to automatically realize the redundancy for two RAID groups once again.

Also, according to the disk array apparatus of the present invention, it is not necessary to prepare an extra redundant disk, since a redundant disk already provided is used. Also, it is possible to cheaply and automatically realize the redundancy once again without a hot spare disk.

In addition, according to the disk array apparatus of the present invention, it is possible to realize the redundancy even if another disk is further failed after one disk is failed and hot-swap is carried out, in case of a device having a hot spare disk.

Furthermore, according to the disk array apparatus of the present invention, it is possible to reproduce data of failed disks, even if one disk is failed and another disk is subsequently failed. More specifically, according to the disk array apparatus of the present invention, it is possible to reproduce a data of a failed data disk B2 even if another data disk B1 fails, since the redundancy is already secured when one disk is failed.

What is claimed is:

1. A disk array apparatus comprising:
first and second RAID (Redundant Arrays of Inexpensive Disks) groups; and
a disk array controller,
wherein said first RAID groups comprises:
a first data disk group of a first disk group and a second disk group which store first and second data, respectively; and
a first redundant disk configured to store a first redundant data for said first and second data,
said second RAID groups comprises:
a second data disk group of a third disk group and a fourth disk group which store second data, respectively; and
a second redundant disk configured to store second redundant data for said third and fourth data,
each of said first to fourth disk group includes at least one disk,
said disk array controller comprises:
a RAID configuration managing section configured to reconfigure said first to fourth disk groups other than a first specific disk and said first and second redundant disks into a third RAID group when said first specific disk which stores a first specific data is failed in said fourth disk group.

2. The disk array apparatus according to claim 1, wherein said RAID configuration managing section issues a first redundant data generation instruction when said first specific disk is failed in said fourth disk group, and
said disk array controller further comprises:
a redundant data generating section configured to generate a third redundant data based on said first to third data, said fourth data other than a data corresponding to said first specific disk, and said second redundant data, and write said third redundant data into said first redundant disk, in response to the first redundant data generation instruction.

3. The disk array apparatus according to claim 2, wherein said redundant data generating section calculates a first exclusive OR of said first to third data, said fourth data other than a data corresponding to said first specific disk, and said second redundant data in response to the first redundant data generation instruction, generates said third redundant data by inverting a first exclusive OR calculation result, and writes said third redundant data into said first redundant disk.

4. The disk array apparatus according to claim 2, wherein said RAID configuration managing section issues a first data reproduction instruction to said first specific disk from a read command to said first specific disk, and
said disk array controller further comprises:
a data reproducing section configured to reproduce said first specific data based on said third data, said fourth data other than a data corresponding to said first specific disk, and said second redundant data in response to the first data reproduction instruction to said first specific disk.

5. The disk array apparatus according to claim 4, wherein said data reproducing section calculates a second exclusive OR of said third data, said fourth data other than the data corresponding to said first specific disk, and said second redundant data in response to the data reproduction instruction to said first specific disk, and reproduces said first specific data by inverting the second exclusive OR calculation result.

6. The disk array apparatus according to claim 2, wherein said RAID configuration managing section reconfigures said first and second RAID groups from said third RAID group when said first specific disk is replaced by a new normal disk, and issues a second data reproduction instruction and a second redundant data generation instruction,
said disk array controller further comprises:
a data reproducing section configured to reproduce said first specific data based on said third data, said fourth data other than a data corresponding to said first specific disk, and said second redundant data in response to the second data reproduction instruction, and write said first specific data in said new normal disk, and
said redundant data generating section generates said first redundant data based on said first and second data in response to the second redundant data generation instruction, and writes said first redundant data in said first redundant disk.

7. The disk array apparatus according to claim 6, wherein said data reproducing section calculates a third exclusive OR of said third data, said fourth data other than a data corresponding to said first specific disk, and said second redundant data in response to the second data reproduction instruction, generates said first specific data by inverting the third exclusive OR calculation result and writes said first specific data in said new normal disk, and
said redundant data generating section calculates a fourth exclusive OR of said first and second data in response to the second redundant data generation instruction, generates said first redundant data by inverting said fourth exclusive OR calculation result and writes said first redundant data in said first redundant disk.

8. The disk array apparatus according to claim 2, wherein when a second specific disk which stores a second specific data is failed in said first to fourth disk groups in a state that said first specific disk is failed, said RAID configuration managing section issues a third data reproduction instruction in response to a read command to said second specific disk,
said disk array controller further comprises:
a data reproducing section configured to reproduce said second specific data based on said first to third data other than a data corresponding to said second specific disk, said fourth data other than a data corresponding to said first specific disk, and said first and second redundant data in response to the third data reproduction instruction.

9. The disk array apparatus according to claim 8, wherein said data reproducing section calculates a fifth exclusive OR of said first to third data other than a data corresponding to said second specific disk, said fourth data other than a data corresponding to said first specific disk, and said first and second redundant data in response to the third data reproduction instruction and generates said first specific data by inverting said fifth exclusive OR calculation result.

10. The disk array apparatus according to claim 2, wherein when a second specific disk which stores a second specific data is failed in said first to fourth disk groups in a state that said first specific disk is failed, said RAID configuration managing section issues fourth and fifth data reproduction instructions in response to a read command to said first specific disk,
said disk array controller further comprises:
a data reproducing section configured to reproduce said second specific data based on said first to third data other than a data corresponding to said second specific disk, said fourth data other than a data corresponding to said first specific disk, and said first and second redundant data in response to the fourth data reproduction instruction, and to reproduce said first specific data based on said second redundant data, and said second specific data, in addition to said third and fourth data other than the data corresponding to said first and second specific disks in case of said second specific disk contained in said third or fourth disk group and said third data and said fourth data other than the data corresponding to said first specific disk in case of said second specific disk not contained in said third or fourth disk group, in response to the fifth data reproduction instruction.

11. The disk array apparatus according to claim 10, wherein said data reproducing section calculates a sixth exclusive OR of said first to third data other than a data corresponding to said second specific disk, said fourth data other than a data corresponding to said first specific disk, and said first and second redundant data in response to the fourth data reproduction instruction, generates said second specific data by inverting said sixth exclusive OR calculation result, and calculates a seventh exclusive OR of said second redundant data, and said second specific data, in addition to said third and fourth data other than the data corresponding to said first and second specific disks in case of said second specific disk contained in said third or fourth disk group and said third data and said fourth data other than the data corresponding to said first specific disk in case of said second specific disk not contained in said third or fourth disk group, in response to the fifth data reproduction instruction, and generates said first specific data by inverting said seventh exclusive OR calculation result.

12. A backup method in a disk array apparatus, comprising:
providing a disk array apparatus which comprises:
first and second RAID (Redundant Arrays of Inexpensive Disks) groups; and
a disk array controller,
wherein said first RAID groups comprises a first data disk group of a first disk group and a second disk group which store first and second data, respectively; and a first redundant disk configured to store a first redundant data for said first and second data;
wherein said second RAID groups comprises a second data disk group of a third disk group and a fourth disk group which store second data, respectively; and a second redundant disk configured to store second redundant data for said third and fourth data, each of said first to fourth disk group including at least one disk;
reconfiguring said first to fourth disk groups other than a first specific disk and said first and second redundant disks into a third RAID group when said first specific disk which stores a first specific data is failed in said fourth disk group;
issuing a first redundant data generation instruction when said first specific disk is failed in said fourth disk group in response to the first redundant data generation instruction;
generating a third redundant data based on said first to third data, said fourth data other than a data corresponding to said first specific disk, and said second redundant data; and
writing said third redundant data into said first redundant disk.

13. The backup method according to claim 12, wherein said generating a third redundant data comprises:
calculating a first exclusive OR of said first to third data, said fourth data other than a data corresponding to said first specific disk, and said second redundant data in response to the first redundant data generation instruction; and
generating said third redundant data by inverting a first exclusive OR calculation result.

14. The backup method according to claim 12, further comprising:
issuing a first data reproduction instruction to said first specific disk from a read command to said first specific disk; and
reproducing said first specific data based on said third data, said fourth data other than a data corresponding to said first specific disk, and said second redundant data in response to the first data reproduction instruction.

15. The backup method according to claim 14, wherein said reproducing said first specific data comprises:
calculating a second exclusive OR of said third data, said fourth data other than the data corresponding to said first specific disk, and said second redundant data in response to the data reproduction instruction to said first specific disk; and
generating said first specific data by inverting the second exclusive OR calculation result.

16. The backup method according to claim 11, further comprising:
reconfiguring said first and second RAID groups from said third RAID group when said first specific disk is replaced by a new normal disk;
issuing a second data reproduction instruction and a second redundant data generation instruction;
reproducing said first specific data based on said third data, said fourth data other than a data corresponding to said first specific disk, and said second redundant data in response to the second data reproduction instruction;
writing said first specific data in said new normal disk;
generating said first redundant data based on said first and second data in response to the second redundant data generation instruction; and
writing said first redundant data in said first redundant disk.

17. The backup method according to claim 16, wherein said reproducing said first specific data comprises:
calculating a third exclusive OR of said third data, said fourth data other than a data corresponding to said first specific disk, and said second redundant data in response to the second data reproduction instruction; and
generating said first specific data by inverting the third exclusive OR calculation result, and
said generating said first redundant data comprises:
calculating a fourth exclusive OR of said first and second data in response to the second redundant data generation instruction; and
generating said first redundant data by inverting said fourth exclusive OR calculation result.

18. The backup method according to claim 11, further comprising:
issuing a third data reproduction instruction in response to a read command to a second specific disk when said second specific disk which stores a second specific data is failed in said first to fourth disk groups in a state that said first specific disk is failed; and
reproducing said second specific data based on said first to third data other than a data corresponding to said second specific disk, said fourth data other than a data corresponding to said first specific disk, and said first and second redundant data in response to the third data reproduction instruction.

19. The backup method according to claim 18, wherein said reproducing said second specific data comprises:
calculating a fifth exclusive OR of said first to third data other than a data corresponding to said second specific disk, said fourth data other than a data corresponding to said first specific disk, and said first and second redundant data in response to the third data reproduction instruction; and
generating said first specific data by inverting said fifth exclusive OR calculation result.

20. The backup method according to claim 11, further comprising:
issuing fourth and fifth data reproduction instructions in response to a read command to said first specific disk, when a second specific disk which stores a second specific data is failed in said first to fourth disk groups in a state that said first specific disk is failed;
reproducing said second specific data based on said first to third data other than a data corresponding to said second specific disk, said fourth data other than a data corresponding to said first specific disk, and said first and second redundant data in response to the fourth data reproduction instruction; and
reproducing said first specific data based on said second redundant data, and said second specific data, in addition to said third and fourth data other than the data corresponding to said first and second specific disks in case of said second specific disk contained in said third or fourth disk group and said third data and said fourth data other than the data corresponding to said first specific disk in case of said second specific disk not contained in said third or fourth disk group, in response to the fifth data reproduction instruction.

21. The backup method according to claim 20, wherein said reproducing said second specific data comprises:
calculating a sixth exclusive OR of said first to third data other than a data corresponding to said second specific disk, said fourth data other than a data corresponding to said first specific disk, and said first and second redundant data in response to the fourth data reproduction instruction; and
generating said second specific data by inverting said sixth exclusive OR calculation result, and
said reproducing said first specific data comprises:
calculating a seventh exclusive OR of said second redundant data, and said second specific data, in addition to said third and fourth data other than the data corresponding to said first and second specific disks in case of said second specific disk contained in said third or fourth disk group and said third data and said fourth data other than the data corresponding to said first specific disk in case of said second specific disk not contained in said third or fourth disk group, in response to the fifth data reproduction instruction; and
generating said first specific data by inverting said seventh exclusive OR calculation result.
